(19) United States
(12) Patent Application Publication
(10) Pub. No.: US 2002/0139183 A1
(43) Pub. Date: Oct. 3, 2002

(54) Mass flow controller device with flat sensor to conform to 1 1/8" semi industry standard

(76) Inventor: Faramarz Frank Azima, San Jose, CA (US)

Correspondence Address: FARAMARZ AZIMA, Suite G, 1206 Old Mtn. View/Alviso Rd., Sunnyvale, CA, 94089, US

(21) Appl. No.: 09/823,230

(22) Filed: Apr. 2, 2001

(51) Int. Cl. G01F 1/68

(52) U.S. Cl. 73/204.27

(57) ABSTRACT

The present invention provides a technique for reducing the size of a mass flow controller (“MFC”) device. The technique includes a device having a novel flat sensor that allows the overall reduction of the body size of an MFC as well as a novel technique of assembling various parts of an MFC.

### BACKGROUND OF THE INVENTION

The present invention relates to a mass flow controller, commonly termed MFC. More particularly, the present invention provides a novel technique, including a device and a method, for maintaining a fluid flow rate of fluids used in, for example, semiconductor processing or the like. Merely by way of example, the present invention is illustrated using a device and methods related to integrated circuit processing. But it will be recognized that the present invention also can be applied to the manufacture of products, such as flat panel displays, hard disk drives, and others.

In the manufacture of semiconductor integrated circuits, process complexity and wafer size tends to increase. For instance, wafer size has increased from one inch to over six inches during the past thirty years. Larger-sized wafers, such as twelve-inch wafers and larger, are being proposed. As wafer size and complexity of processing increase, the gases used for the manufacture of the integrated circuits also become more important. In particular, control of a selected flow rate range for a process step (e.g., plasma etching (“PE”) and chemical vapor deposition (“CVD”)) becomes important. Accordingly, mass flow controllers have been used to selectively control fluid flow rates of selected process steps.

In the manufacture of semiconductor integrated circuits, mass flow controller is a component within the Gas Box. Gas Box is an enclosed metal platform. It serves as a sub-system of a process control equipment such as CVD, Diffusion or Etch System. A typical Gas Box holds within mass flow controllers, pressure regulators, pressure transducers, assembly hardware, surface mount (hence surface mount technology) on manifold bases sitting on top of a substrate plate acting as a base. The industry's trend is now the continuous reduction of the size of subsystem assembly such as Gas Box. As of today, the standard measurement of the base of the surface mounted component is 1⅛″ (1.125×1.125.) All components used in the Gas Box has been redesigned and reduced in size to conform to this standard with the exception of mass flow controllers. At this point, the industry is still using the older larger standard and retro fitting of mass flow controllers into the Gas Box through adding extra non-standard hardware.

Numerous mass flow controllers are on the market today. MFCs typically include four functional blocks, illustrated in FIG. 1. A bypass 46 conveys most of the gas flow (indicated by arrows) through the MFC and across the inlet and output of a sensor assembly 5. The sensor assembly includes a relatively small tube that draws a small amount of gas from the bypass and measures the gas flow by heating the gas and detecting how much heat the gas flow carries away. The flow through the sensor tube is calibrated to the flow in the bypass for particular types of gases, as different gases have different heat capacities. The sensor assembly 5 is wired to an electronic control circuit 7, which adjusts a control valve 9 to provide the desired total flow (through the bypass) according to the measured flow through the sensor assembly. The sensor assembly 5 typically includes a relatively thin sensor tube through which the gas flows, a heater to heat the gas in the sensor tube, and a temperature measuring devices, or sensors, deployed on either side of the heater to provide a differential temperature reading that corresponds to the heat transport of the mass of a particular gas flowing through the sensor tube.

A typical sensor assembly is illustrated in FIG. 3A. Accuracy and response of the sensor assembly is important for good flow control. For accuracy, it is desirable that the differential temperature reading arise from the heat transferred through the sensor tube 26 by the fluid, and not arise from other sources, such as heat traveling down the sensor tube 26, heat conducted from the heater to the sensor through the media surrounding the sensor tube, or heat arriving at the sensor from another source, such as the bypass. The response of the sensor assembly relates to the speed with which the sensor assembly heats up or cools down after a change in heater power. Quicker response allows the flow to be controlled within finer limits. The heater and temperature sensor typically are both made by winding a wire around the sensor tube to form a heater coil and sensor coils 202A-B. Electric current flowing through the heater coil heats the sensor tube and the gas inside the sensor tube. The flow of gas from the heated zone of the sensor tube to the downstream sensor coil creates a temperature differential between the downstream sensor coil and the sensor coil that is upstream from the heater.

Typical sensor coils operate on the principle that the resistance of a metal increases with increasing temperature. The sensor coils are connected to electronic circuits that measure the resistance of each coil. The longer and thinner the wire of a sensor coil is, the higher the coil's resistance will be and, generally speaking, the greater the coil's temperature sensitivity will be. Increased temperature sensitivity allows more accurate and more stable control of the gas flow, so it is desirable to make the coils out of fine wire.

The primary reason for the relatively large size of MFC compare to other components of the Gas Box is the size and shape of the sensor. A conventional sensor consists of a U-shaped tube welded to the base plate as illustrated in FIG. 3 B. This design requires a nominal one (1) inch height and therefore leaving no spare room for the rest of the components in the body of MFC. The other limitation on the existing MFC design is the way the valve is attached to the block. In the existing designs, the flow path is through side-channel going through the valve and the sensor. The flow path is through the U-shaped sensor and then through the U-shaped flow path in the valve. This causes the design of the MFC to be bulky and awkward to reduce in size.

There are several manufacturers of mass flow controllers including, among others, Unit Instruments, Inc. (“Unit”), Brooks Instruments (“Brooks”), and Tylan General (“Tylan”). These manufacturers have a broad range of products to cover a variety of flow ranges and flow directions, which are used in the manufacture of integrated circuit devices. For instance, Unit has at least ten different products for the purpose of covering a variety of situations. Tylan has at least seven different products. As for Brooks, it has about eight products or more for covering different fluid flow situations, such as flow volume, delivery pressures, fluid type, and accuracy.

A limitation with these conventional mass flow controllers is their size that does not conform with the industry's 1⅛″ standard for the base of the surface mounted component. This industry standard requires every component mounted on the manifold base of the Gas box to be within the size 1⅛″ on the bottom and no more than 5 inches tall. As of today, all components have conformed to this standard except for MFCs. Accordingly, the Gas Box manufacturers have to accommodate for the larger out of standard size of MFC by having a non-standard component on the manifold that acts as a flow conduit between components. A conventional MFC takes 200% more space than other components increasing the cost of production because of the necessity to use larger non-standard gas box.

From the above, it is seen that a mass flow controller that would conform to the industry standard as other components would be desirable.

### SUMMARY OF THE INVENTION

According to the present invention, a technique, including a device and method, for standardizing the size of mass flow controller according to the present industry standard, for example, semiconductor processing or the like is provided. In an embodiment, the present invention provides an MFC that is designed specifically for the 1⅛″ surface mount standard. This allows a MFC to be fitted into the manifold base as the other components, thus eliminating the necessity to build a special base for the MFC and allowing the use of the standard base for MFC.

In a specific embodiment, the present invention provides a fluid mass flow control device having a novel sensor design to allow for the sensor to be flat and thus smaller in size. The traditional sensor uses a U-shaped tube attached to a base. The present invention has a novel design that includes two-base plate with an angle typically 45 degrees holes drilled for installation of the sensor tube. This allows the sensor tube to have a small arch and therefore being housed within the height of the plate as opposed to rising an inch about the plate.

In an alternative specific embodiment, the present invention provides a novel flow path that loops around the height of the MFC from the inlet to the outlet and therefore the ability to efficiently use the space within the body of the MFC rather than following the old flow path. In the conventional flow path, the flow path to the valve is not continuous rather perpendicular. In the present invention, the flow path is elliptical.

In yet another embodiment, the present invention provides a novel assembly of the components of mass flow controller such that its size could be reduced to fit the industry standard. The base of the MFC is designed to follow 1⅛×1⅛ standard set by the semi industry. The body of the MFC is also designed to follow the same standard with the maximum height of 5 inches. The novel assembly sets the base block as the foundation to contain the laminar flow element and the inlet and outlet ports, and the sensor attached to the side body via a cavity. The PC board is attached to the sensor and the body at the point of the sensor. The retaining plate sits on the top of the base block and functions as a unidirectional device that has two separate designs allowing change of flow direction. On top of the retaining plate sits the valve assembly that contains an orifice, a spring and a magnetic plunger. Attaching the base block, retaining plate and valve assemble together are four fasteners and in between each plate there is a metal seal. On top of the valve assembly sits a magnetic coil encapsulated in magnetic shroud and magnetic core. The PC board is covered by a metal cover to eliminate undesirable electrical conduction. At the base plate there are four holes for attachment fasteners placed such that they do not interfere with the flow chamber. The flow chamber and outlet ports are placed such that no screw hole get closer than 0.03 inches to enhance the pressure and leak integrity. The sensor using the two end plates is designed such that the total thickness of the sensor does not exceed 0.25 inches. The base block is designed to contain nominal 1.7 inch long laminar element thus allowing a very high flow as much as 100 liters of nitrogen or equivalent.

Numerous benefits are achieved by way of the present invention over pre-existing techniques. In particular, the present invention can provide a single mass flow control unit that fits the industry standard. These attributes eliminate the need for manufacturing a special component for mounting MFCs on the manifold base. Accordingly, the present invention achieves these benefits and others, which will be, described in further detail throughout the specification. A further understanding of the nature and advantages of the present invention may be realized by reference to the latter portions of the specification and attached drawings of the present invention.

### BRIEF DESCRIPTION OF THE DRAWINGS

FIG. 1 is a simplified block diagram of a conventional MFC;

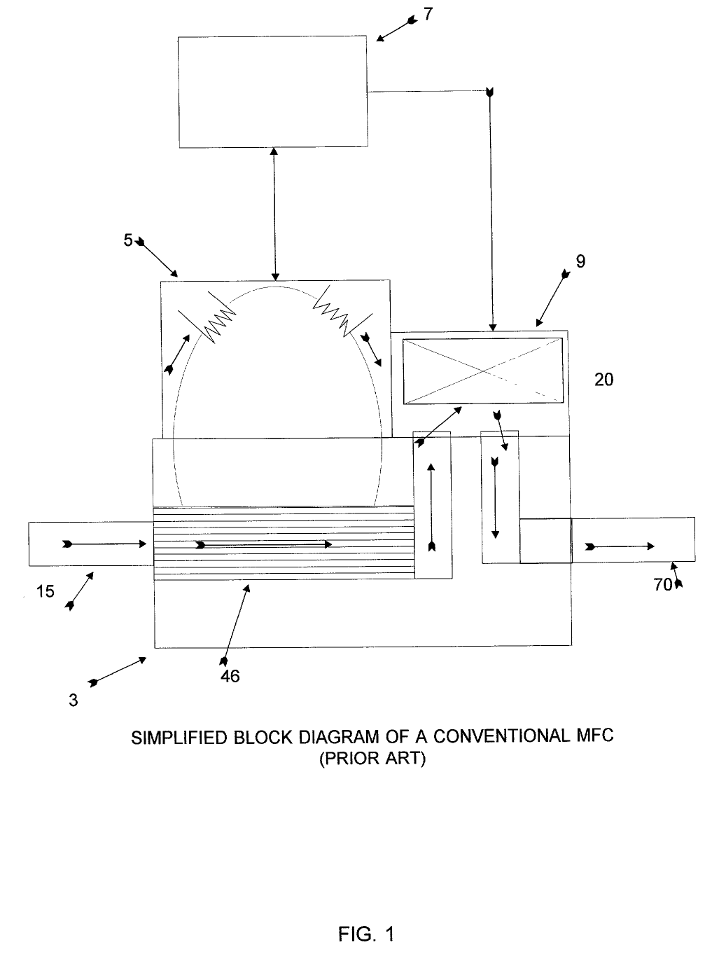

FIG. 2 is a simplified front-view and side-view diagrams illustrating operation and assembly of an MFC according to the present invention;

FIG. 3A is a simplified cross section of a conventional thermal flow sensor;

FIG. 3B is a simplified cross section of a conventional U-shaped tube of thermal flow sensor;

FIG. 3C illustrates a sensor tube with a terminal board;

FIG. 3D is a simplified cross section of flat thermal flow sensor according to the present invention;

FIG. 3E is a simplified cross section of thermal flow sensor and the flow chamber according to the present invention;

FIG. 4A is a simplified flow path of a conventional MFC;

FIG. 4B is a simplified flow path of an MFC according to the present invention;

### DESCRIPTION OF SPECIFIC EMBODIMENTS

The present invention provides a technique including a device and method for maintaining a fluid flow rate of fluids used in, for example, semiconductor processing or the like. In one embodiment, the present invention provides an MFC capable of being mounted on the industry standard manifold plate which is used in a variety of semiconductor processing operations. The standardization is achieved by way of a novel flat sensor design that allows an MFC to be build in much smaller size. In another embodiment, a precision-wound sensor tube allows the flow of gas to the sensor in a parallel manner rather than U-shaped. This achieved by splitting the base of the sensor into two halves and nominal 45 degrees drilling through the body to weld the sensor tube into the end-plates.

1. Mass Flow Controller

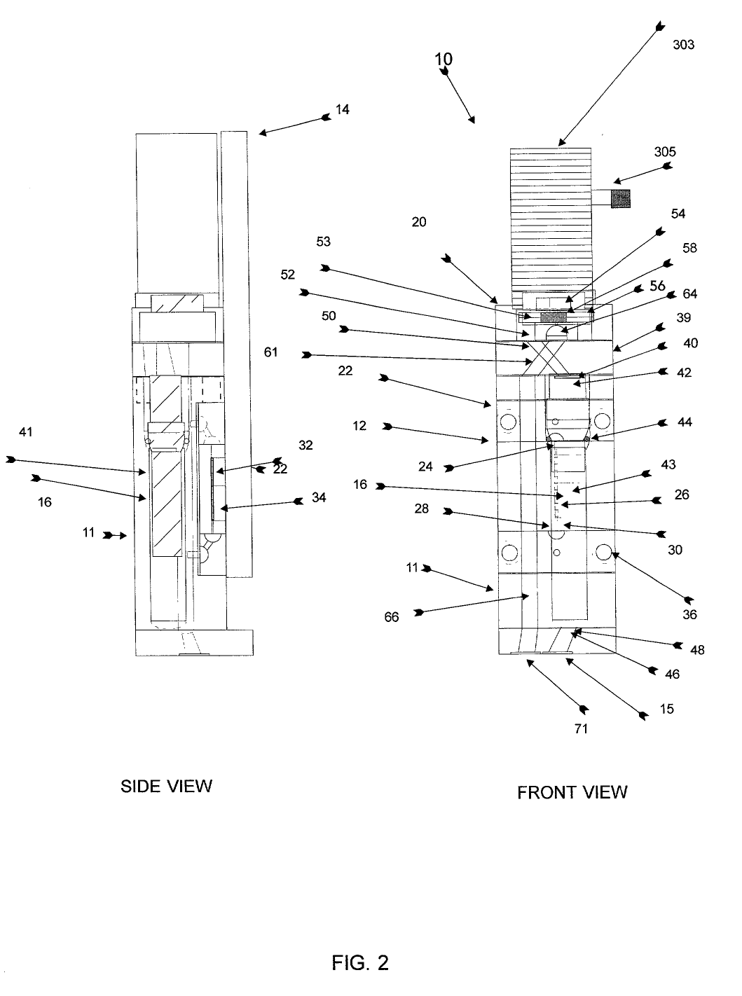

Mass flow controllers, commonly termed MFCs, are used whenever accurate measurement and control of a gas(s) is desired. An MFC includes a mass flow meter, a proportional controller, and other elements. FIG. 2, for example, illustrates a simplified front-view diagram of a mass or fluid flow controller 10 according to the present invention. This diagram is merely an illustration and should not limit the scope of the claims herein. One of ordinary skill in the art would recognize other variations, alternatives, and modifications.

The MFC 10 generally includes a mass flow meter 12, a controller 14, and other elements. The mass flow meter 12 divides fluid flow 15 between a flow restriction element or by-pass element 16, where most of the flow passes, and sensor tube 26, where mass flow is measured. Sensor tube 26 is located in a sensor unit 22. Controller 14 includes, among other elements, a variable displacement solenoid valve, which may be a magnetic proportional control valve assembly 20. The controller 14 drives the valve to a position so that measured flow equals a desired flow 71 set-point for a particular process.

By-pass element 16 is generally removable from the main chamber 43 of the main body 11. In particular, by-pass element 16 is insertable into main chamber 43 where valve retaining plate 39 is not present. By-pass element 16 is replaceable or detachable from main chamber 43 in the main body 11 by removing valve retaining plate 39, which holds and seals the by-pass element 16 into place of the main body 11. By-pass element 16 also includes region 42 holds or clusters one or more of the laminar flow tubes into the by pass element and the outside cavity 40 allows sensor gas flow. Region 44 of the by-pass element 16 includes an annular periphery (i.e., rounded corners) to seal the-by-pass element 16 to the main chamber 43 of main body 11. Fluid traverses through one or more of the laminar flow tubes and enters into main chamber 43, which is coupled to valve 20 to through conduit 50 within valve retaining plate 39. By-pass element 16 also has a relatively long elongated vertical structure for providing a wide range of fluid flow ranges. By-pass element 16 makes effective use of the main body 11 by extending into a region running parallel to the sensor unit 22 underneath valve 20.

Additional details regarding the by-pass element 16 are described below. Sensor unit 22 is coupled to the main body 11 by way of sensor tube ports 24 and 28. Sensor unit 22 is also coupled mechanically to main body 11 using, for example, fasteners 36, e.g., screws, or bolts. A portion of fluid flows from region 46 of the by-pass element 16 into sensor tube port 28. Sensor tube port 28 is a 45 degree entrance which provides fluid into straight sensor tube 26. The sensor unit 22 also includes temperature sensing elements 32 and 34 for monitoring a difference in temperature between sensor tube ports 24 and 28. Fluid leaves sensor unit 22 through sensor tube port 24 and enters cavity region 40. Fluid leaves by-pass element 16 through valve-by-pass conduit 50 and enters valve assembly 20, which selectively adjusts fluid flow to a desired set-point. Fluid leaves valve-by-pass conduit 50 and enters valve chamber 52 in the valve assembly 20. From the valve chamber 52, fluid traverses under valve seat 58, through orifice 53, to an inlet/outlet conduit 61. A combination of at least a valve plunger 54 and a valve spring 56 actuates valve seat 58 to selectively control fluid flow through the valve 20. Upon traversing through orifice body 53, fluid enters and traverses through inlet/outlet conduit 61. The inlet/outlet conduit 61 connects to the body conduit 66 and exit at port 71.

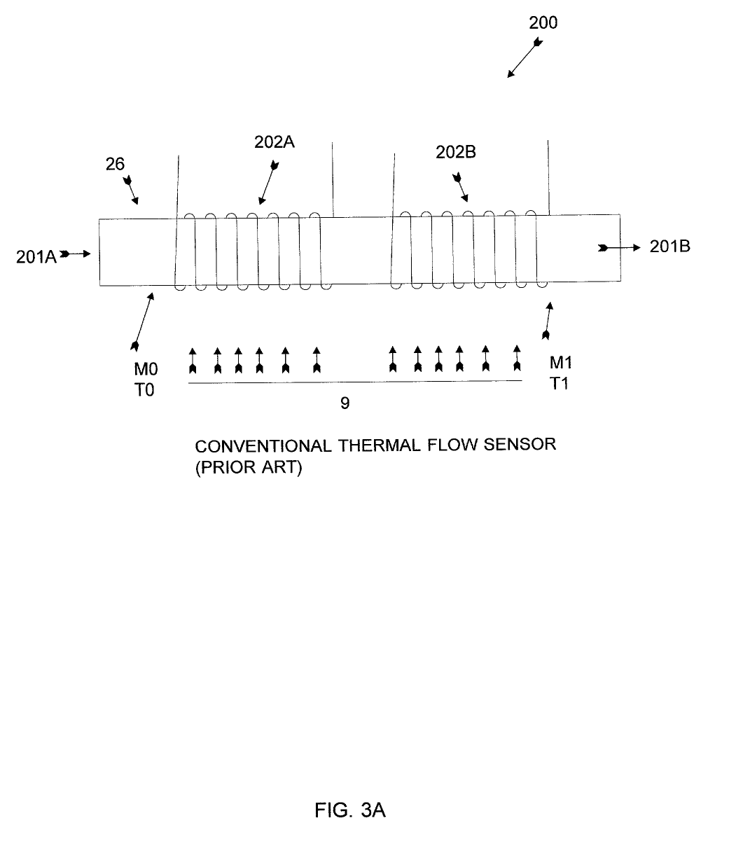

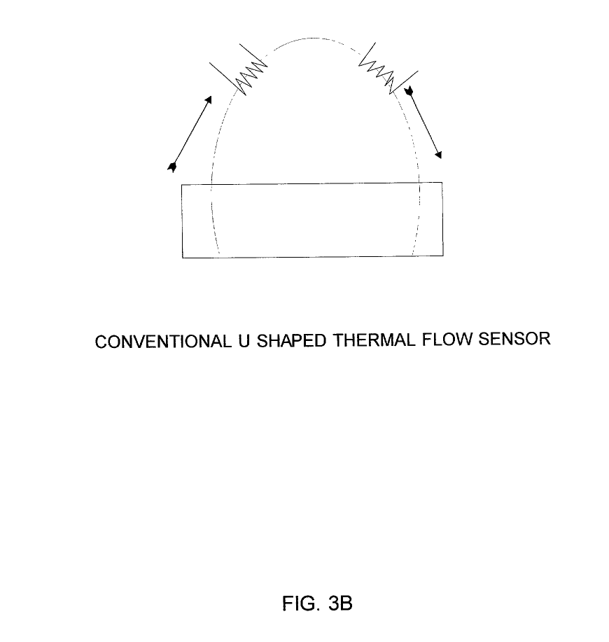

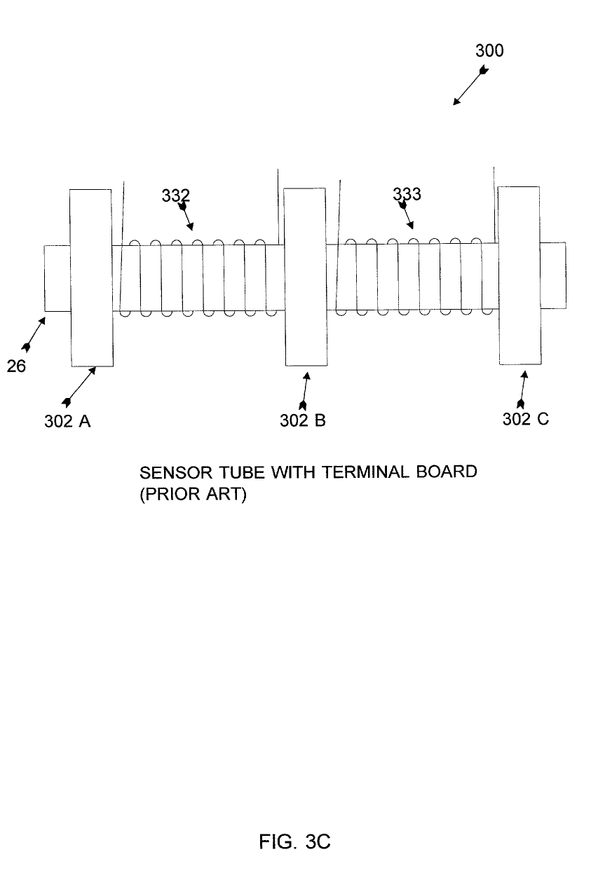

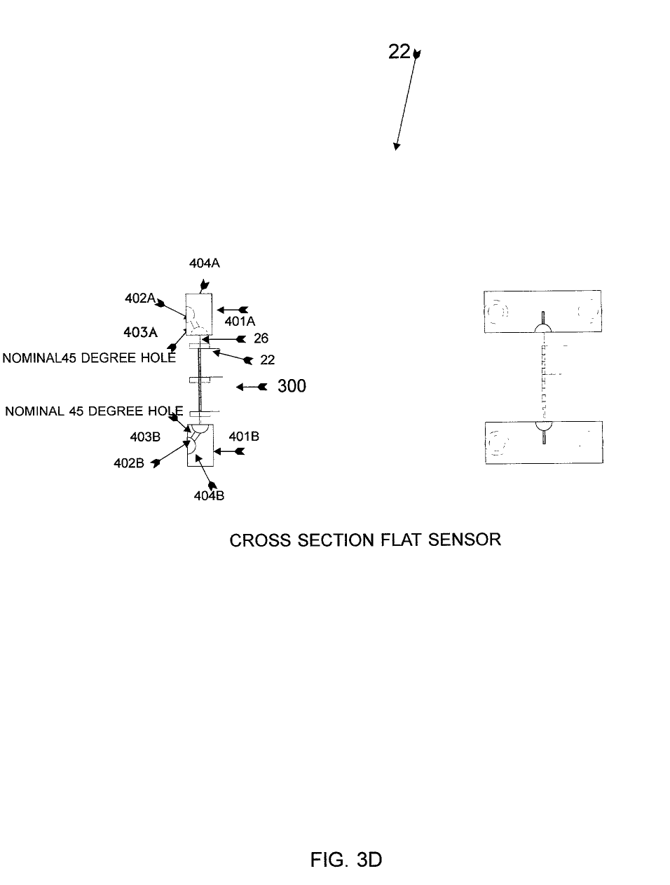

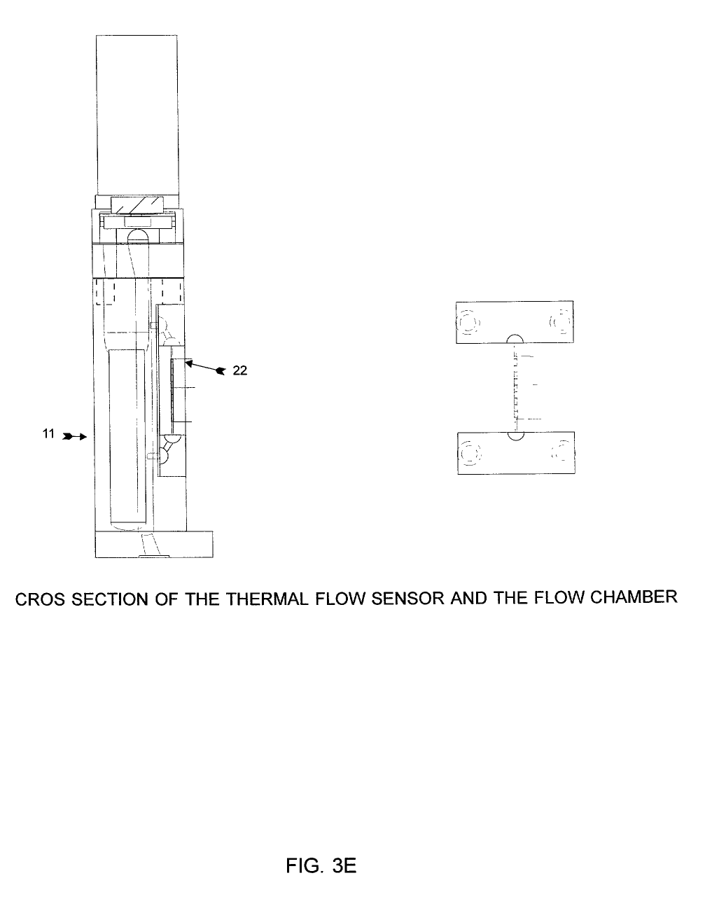

In theory, for example, mass flow meter uses thermal properties of a gas to measure mass flow rate. In particular, mass flow meter generally relies upon a principle that each molecule in a gas has a specific ability to pick up heat. The principle relates to a property of the gas commonly termed the “specific heat” (Cp), which is the specific heat at constant pressure. The specific heat relates at least to mass and physical structure of the gas and can be determined experimentally or looked up in a reference book such as, for example, the CRC Handbook of Chemistry and Physics, but is not limited to this reference book. The specific heat is often known for a variety of gases and is, for the most part, insensitive to changes in pressure and/or temperature. Mass flow meter operates by adding a selected amount of heat to a gas and monitoring a change in temperature of the gas. By way of the change in temperature and heat, a mass flow rate of the gas can be determined. Referring to FIG. 3A, for example, an illustration of mass flow sensor operation 200 is depicted. A gas 201A enters sensor tube 26 at an initial temperature (“T₀”) and mass flow rate

(“m₀”).

Heat (“q”) is applied to the tube to increase temperature of the gas in the tube 26. In particular, resistive heat can be applied to tube 26 using resistive heating element 202A-B. Outgoing gas 201B leaves tube at a higher temperature (“T₁”) and mass flow rate (“m₁).

Conservation of mass suggests that incoming mass flow rate m₀ is equal to outgoing mass flow rate m₁. A relationship between heat, heat capacity, mass flow rate, and change in temperature is governed by the following equation:

q=mCₚdt

where

q is heat applied to the gas in the tube;

m is mass of the gas;

Cₚ is heat capacity at constant temperature; and

dt is differential change in gas temperature.

Referring to the equation, heat (q) applied to the tube 26 can be measured by way of measuring an electric current at a specific voltage applied to the tube. As noted above, the heat capacity (Cₚ) can be found in a reference book such as, for example, the CRC Handbook of Chemistry and Physics, but is not limited to this reference book. Differential temperature (e.g., T₀ T₁,) also can be measured by way of resistivities. Accordingly, mass flow rate (m) in the sensor tube is readily determined by way of the equation.

Total or net mass flow rate for the mass flow controller can be determined by a flow relation between the sensor tube and the by-pass element. As noted, most of the flow shunts through by-pass element and a portion of the flow splits off into the sensor tube in the sensor. A percentage of fluid flow through the sensor tube is relatively constant in relation to the fluid flow through the by-pass element for a selected fluid flow operating range. By way of measuring the fluid flow passing through the sensor tube, total flow can be determined, as long as the percentage of flow between the tubes remains substantially constant. Preferably, fluid flow through the sensor tube has a substantially laminar profile to maintain accurate fluid flow measurement and preserve the relatively constant flow relation between the by-pass element and the sensor tube.

Referring again to FIG. 2, the sensor unit 22 is coupled to a control unit 14. The control unit 14 provides an electric current to the electromagnet 303, which is coupled to the valve assembly 20. The control unit provides up to about 30 volts to the electromagnet through magnet harness wires 305. The voltage supplied to the electromagnet, which corresponds to a current through the electromagnet coil 303, is proportional to the difference between the output of the sensor unit 22 and a set-point. The set-point is established by calibrating the MFC for a particular flow of a particular type of gas. The difference between the output of the sensor unit and the set-point is an indication of the difference between the actual flow through the MFC and the desired flow. A greater difference between the actual and desired flow results in more voltage being supplied to the electromagnet 303 from the control unit 14. The valve plunger 54 is magnetic, that is, the material of the valve plunger is attracted by a magnetic field. As the electromagnet 303 is energized by the control unit 14, the magnetic valve plunger 54 is drawn toward the electromagnet and the magnetic upper valve body (see FIG. 2). The valve seat 58 is screwed or welded into the valve plunger 54, so that the valve seat 58 rises off the orifice 53, thus allowing fluid to flow from the valve chamber 52 through the orifice 53, and out the conduit 61, when the electromagnet 303 is energized. A valve spring 56 returns the valve seat 58 to the orifice 53 when the electromagnet 303 is de-energized.

FIG. 3C illustrates a simplified drawing of a portion of the sensor assembly 300. The sensor tube 26 goes through three terminal boards 302A-302C. A first sensor coil 332, and a second sensor coil 333 are wound around the sensor tube 26 between the terminal boards. The sensor and heating element coils are wound from a fine wire. As shown in FIG. 3C, the sensor tube 26 is supported at only a few points by the terminal boards 302A-302C. Most of the sensor tube is surrounded by air, as are the sensor coils and the heating element coil, allowing rapid thermal response.

FIG. 3D shows a simplified flat sensor tube assembly 22 after the coils have been wound and before the sensor tube assembly is encased by insulating materials. The sensor tube assembly 300 is attached to two half plates 401 A, 401 B. Each half plate was drilled in a nominal 45 degrees angle to accept the sensor tube 26, which was butt welded 402A, 402B to each half plate. The half plates were drilled with two half-spheres perpendicular to each other 403A, 403B with a minimum of spacing of 0.030 of an inch (variable depending on the diameter of the tube and the welding process) in order to have enough materials to accomplish welding. This 45 degrees angle also allows the sensor tube to bend in a radial configuration immediately to form a straight line. When the gas enters the first spherical chamber 404B, it will automatically follow the 45 degree route and enter into the straight line of the sensor tube 26 exiting from the other spherical chamber 404A on the opposite plate 401A. Since the tube 26 is not bend in a drastic form, and therefore, it is not as prone to chemical coercion because of stresses created due to the bending forces. This straight line approach with 45 degree bend allows for much easier cleaning of the inside of the sensor tube 26 before and after use. This process also helps to remove stress from the sensor wire 333 by removing the bending force. The flat sensor 22 allows the MFC to be reduced in size. The reduction of the size in turn allows the MFC to conform with the industry standard for the Gas Box reducing the cost of manufacturing and increasing the efficiency of the manufacturing process.

FIG. 3E shows the sensor 22 attached to the body of the flow body 11. The result of the flat sensor is the parallel flow of the gas. The flat sensor allows straight flow through the sensor tube 26 which in turn allows the reduction of sensor size. The parallel flow also results in reduction of clogging as well as particles generation in the sensor tube 26.

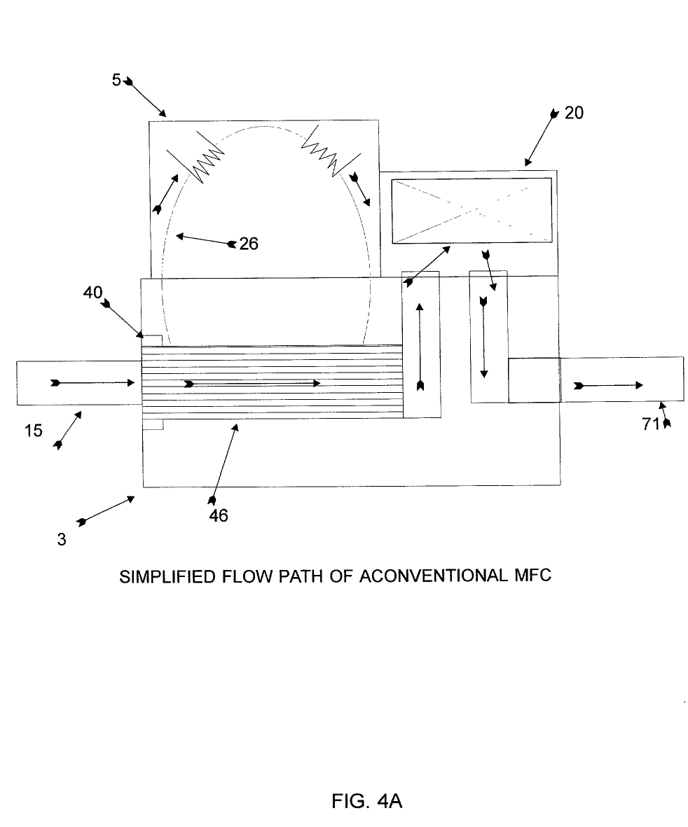

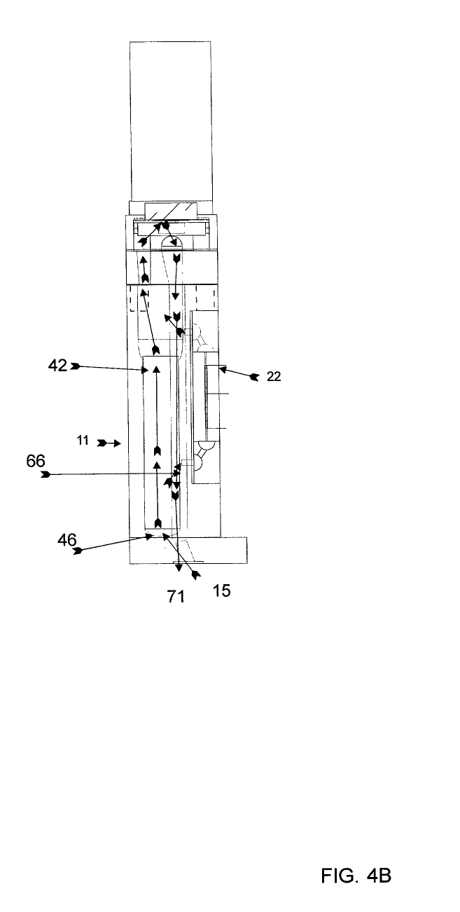

FIG. 4A shows the flow of the gas in a conventional MFC. The flow 15 enters the chamber 40 and splits. One flow goes through the laminar flow element 46 into the valve 20 and out at port 71. The other flow enters the sensor tube 26 and exits into laminar flow element 42. The result is an exaggerated perpendicular sensor flow. FIG. 4B illustrates the flow path in the present invention which is elliptical. The flow 15 enters the chamber 46 and splits. One flow goes through laminar flow element 42 and conduit 50 and under the valve seat 58. It curves and enters port 61 and exits through port 71. Another flow runs through sensor unit 22 parallel to the laminar flow element 42 and enters back into chamber 46 and exits into 61 following the same path as the first flow.

While the above is a full description of the specific embodiments, various modifications, alternative constructions and equivalents may be used. For example, while the description above is in terms of using the MFC for semiconductor processing applications, it would be possible to implement the present invention with almost any application, including, for example, the manufacture of flat panel displays, hard disk drives, medical devices, or any other article of manufacture or chemical, which uses controlled fluid flow. Additionally, the invention can be applied to a variety of industries such as medical, petroleum, environmental, chemical, biomedical, materials, or the like. Therefore, the above description and illustrations should not be taken as limiting the scope of the present invention which is defined by the appended claims.

What is claimed is:

1. A devise for measuring the flow of gas, the devise comprising:
a sensor tube;
a coil of wire, the wire having an end, the coil wound around the sensor tube;
a first end plate attached to a first end of the sensor tube and a second end plate attached to a second end of the sensor tube.

2. The devise of claim 1 wherein the sensor tube is welded in an angle typically 45 degrees into the end-plate.

3. The devise of claim 1 wherein the end-plates contain two machined half spheres perpendicular to each other.

4. The devise of claim 1 wherein the two half spheres contain a spacing apart enough from each other to allow for a small hole to be drilled for as low as 0.011 inches.

5. The devise of claim 1 wherein the two half spheres have a spacing apart enough to have sufficient materials for welding.

6. The devise of claim 1 wherein the end plates due to spherical design allow placing surface to surface round metal seal at the bottom of the plate.

7. The devise of claim 1 wherein the sensor tube contains winding wire comprising of niachrome wire less than about 4 mils thick.

8. The devise of claim 1 wherein the sensor tube goes straight from one end plate to another via the sensor cavity.

9. The devise of claim 1 wherein the sensor is essentially flat attached to the side of the body.

10. The devise of claim 1 wherein the base block is the foundation.

11. The devise of claim 1 wherein the retaining plate sits on top of the base block connecting to the valve assembly.

12. The devise of claim 1 wherein the valve assembly is fastened to the retaining plate.

13. The devise of claim 1 wherein the magnetic coil is fastened to the valve assembly.

14. The devise of claim 1 wherein the-by-pass element is located inside of the base block's flow chamber.

15. The devise of claim 1 wherein the PC board is fastened parallel to the body of the base block.

16. The devise of claim 1 wherein the sensor is located inside the base block.

17. The devise of claim 1 wherein the body is essentially rectangular with maximum height of 5″.

18. The devise of claim 1 wherein the base is measured at 1⅛×1⅛ inches.

19. The devise of claim 1 is assembled such that it fits the 1⅛×1⅛ inches semi standard Gas Box.
